(19) United States
(12) Patent Application Publication
(10) Pub. No.: US 2023/0226763 A1
(43) Pub. Date: Jul. 20, 2023

(54) ADDITIVE MANUFACTURING PLATFORM SYSTEM

(71) Applicant: FERMI RESEARCH ALLIANCE, LLC, Batavia, IL (US)

(72) Inventors: Timothy Ring, Batavia, IL (US); Derek Plant, Batavia, IL (US)

(21) Appl. No.: 18/098,022

(22) Filed: Jan. 17, 2023

Related U.S. Application Data
(60) Provisional application No. 63/301,006, filed on Jan. 19, 2022.

(51) Int. Cl. B29C 64/245; B29C 64/30

(52) U.S. Cl. CPC B29C 64/245; B29C 64/30; B33Y 30/00

(57) ABSTRACT

Many materials (e.g., PVDF) are difficult to use in additive manufacturing processes because the material does not bond to the build platform of additive manufacturing machines. In order to use such materials, a build platform can use a difference in air pressure to hold a base film in position on a top plate of the build platform. An object is to be printed using the material and the base film is of a material that the material will bond to during the printing process. The difference in air pressure may be achieved using a build plate with a voided internal region and a top plate with apertures. A low pressure source can draw a vacuum in the voided internal region. Placing the base film over the apertures causes the base film to be held in place by the difference in air pressure.

### CROSS REFERENCE TO RELATED PATENT APPLICATION

This patent application claims the priority and benefit, under 35 U.S.C. § 119(e), of U.S. Provisional Patent Application Ser. No. 63/301,006, filed Jan. 19, 2022, and titled “ADDITIVE MANUFACTURING PLATFORM SYSTEM”. U.S. Provisional Application Ser. No. 63/301,006 is incorporated herein by reference in its entirety.

### STATEMENT OF GOVERNMENT RIGHTS

The invention described in this patent application was made with Government support under the Fermi Research Alliance, LLC, Contract Number DE-AC02-07CH11359 awarded by the U.S. Department of Energy. The Government has certain rights in the invention.

### TECHNICAL FIELD

Embodiments are generally related to additive manufacturing. Embodiments are further related to methods and systems for additive manufacturing and 3D printing. Embodiments are further related to methods and systems for improving the build platform of additive manufacturing devices. Embodiments are additionally related to methods and systems for producing improved build platforms configured for use with a variety of materials.

### BACKGROUND

Improvements in additive manufacturing have created unprecedented opportunities to design and build custom parts, products, etc. The opportunity to build specialized parts, on site, without the need to order custom parts has created a new frontier in custom design and manufacturing. Likewise, scientists can now develop and produce equipment necessary for scientific apparatus on a dramatically truncated timeline.

While additive manufacturing and/or 3D printing offer exceptional opportunities, there remain various challenges for practical applications. One such obstacle is that additive manufacturing is limited to certain materials and can only be built on certain compatible base materials. Likewise, some filament materials for additive manufacturing machines are much easier to use than others. Many custom parts, products, or scientific apparatuses require specialized materials. Practically speaking, this creates a serious problem when the required material is not one of the select few materials that are compatible with the additive manufacturing process.

For example, it is relatively simple to use additive manufacturing to construct parts of monofilament, plastics, polymers, and certain metals. However, other materials are much more difficult to print with additive manufacturing techniques. Polyvinylidene fluoride (PVDF), is a thermoplastic with numerous physical characteristics that make it a good choice for various applications. However, it is often difficult to build with PVDF on conventional build platforms. It is also difficult or impossible to print on nonstick surfaces.

Common approaches to printing on unusual or nonstick surfaces include clamps, adhesives, or heat treatment. However, these solutions are fraught with problems. Clamps often allow the underlying substrate to move. Even tiny movements of the underlying substrate can ruin a build. Likewise, adhesives can damage the underlying base surface and heat treatments often result in the build warping.

As such, there is a need in the art for methods and systems that can be used for additive manufacturing on various base materials as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

One aspect of the subject matter described in this disclosure can be implemented in a system. The system can include a build platform for an additive manufacturing machine, and at least one aperture in the build platform that is positioned to use a difference in air pressure to force a base film onto the build platform, wherein the build platform is configured for the additive manufacturing machine to produce an additively manufactured object on the base film, and wherein the additively manufactured object bonds to the base film.

Another aspect of the subject matter described in this disclosure can be implemented by a method. The method can include placing a base film on a build platform of an additive manufacturing machine, using a difference in air pressure to force the base film onto the build platform, using the additive manufacturing machine to produce an additively manufactured object on the base film, and removing the base film and the additively manufactured object from the build platform after relieving the difference in the air pressure, wherein the additively manufactured object bonds to the base film while the additively manufactured object is produced by the additive manufacturing machine.

Yet another aspect of the subject matter described in this disclosure can be implemented in a system. The system can include a means for producing an additively manufactured object, and a means for using a difference in air pressure to selectively attach a base film to the means for producing the additively manufactured object, wherein the additively manufactured object bonds to the base film while the additively manufactured object is produced by the means for producing the additively manufactured object.

In some implementations of the methods and devices, the system further includes the additive manufacturing machine, and a low pressure source that pulls air from a vacuum port of the build platform to thereby create the difference in the air pressure. In some implementations of the methods and devices, the system further includes a top plate, a bottom plate, a vacuum port configured for pulling air from a voided internal region between the top plate and the bottom plate, a spacer material sheet in the voided internal region, and a sealing ring between the top plate and the bottom plate that seals the voided internal region, wherein the at least one aperture passes through the top plate to the voided internal region, wherein the top plate, the bottom plate, the vacuum port, the spacer material sheet, and the sealing ring are components of the build platform, and wherein pulling the air from the vacuum port creates the difference in the air pressure that forces the base film onto the build platform.

In some implementations of the methods and devices, the additively manufactured object is a polyvinylidene fluoride (PVDF) object. In some implementations of the methods and devices, the base film is a polyvinylidene fluoride (PVDF) base film. In some implementations of the methods and devices, the additively manufactured object includes polyvinylidene fluoride (PVDF), and the PVDF bonds to the base film.

In some implementations of the methods and devices, the build platform includes a vacuum pulling assembly that includes a vacuum tab and a vacuum port on the vacuum tab, and pulling air from the vacuum port creates the difference in the air pressure that forces the base film onto the build platform. In some implementations of the methods and devices, the vacuum pulling assembly includes a magnet, wherein the magnet is positioned to use a magnetic force to hold a vacuum hose to the vacuum port. In some implementations of the methods and devices, a magnetic force holds a vacuum hose to a vacuum port of the build platform, and pulling air from the vacuum hose creates the difference in the air pressure that forces the base film onto the build platform.

In some implementations of the methods and devices, an exterior edge of the base film is sealed to a top plate of the build platform. In some implementations of the methods and devices, the base film is textured to facilitate gas conductance into the at least one aperture of the build platform. In some implementations of the methods and devices, a mesh between the base film and the build platform facilitates gas conductance into the at least one aperture of the build platform. In some implementations of the methods and devices, the difference in the air pressure forces the base film onto the build platform continuously during production of the additively manufactured object.

In some implementations of the methods and devices, the build platform includes a top plate, a bottom plate, a vacuum port configured for pulling air from a voided internal region between the top plate and the bottom plate, at least one aperture passing through the top plate to the voided internal region, a spacer material sheet in the voided internal region, and a sealing ring between the top plate and the bottom plate that seals the voided internal region, wherein pulling the air from the vacuum port creates the difference in the air pressure that forces the base film onto the build platform.

The aforementioned aspects and other objectives and advantages can now be achieved as described herein. Various additional embodiments and descriptions are provided herein.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 is a high-level conceptual diagram illustrating an additive manufacturing machine that uses a difference in air pressure to hold a base film to a build platform according to some aspects.

FIG. 2 is a diagram illustrating components of a build platform according to some aspects.

FIG. 3 is a diagram illustrating a cut view of a build platform according to some aspects.

FIG. 4 is a diagram illustrating a build platform attached to a low pressure source according to some aspects.

FIG. 5 is a diagram illustrating a spacer material sheet and a sealing ring on a top plate according to some aspects.

FIG. 6 is a diagram illustrating a bottom plate stacked on the spacer material sheet, the sealing ring, and the top plate of FIG. 5 according to some aspects.

FIG. 7A is a diagram illustrating an exterior edge of the base film sealed to the top plate according to some aspects.

FIG. 7B is a diagram illustrating a mesh under the base film of FIG. 7A according to some aspects.

FIG. 8 is a high-level conceptual diagram illustrating a vacuum pulling assembly that includes a magnet that is positioned to use a magnetic force to hold a vacuum hose to the vacuum port of a build platform according to some aspects.

FIG. 9 is a high-level flow diagram illustrating a method for using a difference in air pressure to hold a base film to a build platform during the manufacture of an additively manufactured object according to some aspects.

Throughout the description, similar reference numbers may be used to identify similar elements.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter, with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. Dimensions or ranges illustrated in the figures are exemplary, and other dimensions can be used in other embodiments. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

The disclosed embodiments are directed to methods and systems used to secure substrates such as sheets, films, or plates of raw material to the “build platform” of an additive manufacturing machine utilizing a difference in air pressure. The term base film is used herein to collectively refer to the sheets, films, plates of raw material, and other substrates that are secured to the build platform by the difference in air pressure.

Components of the disclosed system can include a build platform for an additive manufacturing device such as a 3D printer. The system can further include a low pressure source (e.g., a vacuum pump, a specially designed manifold, etc.), adhesive tapes, putty, grease, various hoses, tubing, various mesh material, fabric, intermediate build platform sections that can utilize O-rings, passageways, swivels, slots, grooves, screen, spacer material sheet, and/or magnets, for the movement of air, gas, or liquid, for the purposes of material friction adhesion to the build surface, build surfaces, or intermediate build surfaces of an additive manufacturing machine. The disclosed embodiments can further use passageways for thermal exchange via liquids or gasses. Control systems, integrated positive feedback systems, spools, belts, cogged drivers, stepper motors, software, switches, valves, wireless, cameras are additional aspects of the disclosed embodiments as further described herein.

In the disclosed embodiments, a film, sheet, or plate of substrate material that will bond with a component filament material, including but not limited to PVDF, can be secured to the “build platform” of an additive manufacturing device. The additive manufacturing device produces an additively manufactured object from the component film material. The component filament may be referred to as filament, printer filament, or 3D printer filament. As used herein, the film, sheet or plate is referred to as a “base film” or material substrate. The base film can be secured in place by reducing the air pressure between the base film and the build platform.

The build plate can include a top plate and a bottom plate. A low pressure area can be created in the internal region between the top plate and the bottom plate. The internal region can be referred to as the voided internal region because a low pressure source can be connected to the build platform such that air in the voided internal region flows from the voided internal region to the low pressure source. For example, small holes in the bottom plate can be operably connected to a vacuum pulling assembly (the low pressure source). The voided internal region may therefore be considered a low pressure area and the area outside the build plate may be considered a high pressure area. A difference in air pressure therefore exists between the outside of the build platform and the voided internal area. Apertures in the top plate can allow air to flow between the outside of the build platform and the voided internal region. As such, air may flow from outside the build platform, through the apertures, to the voided internal region, and then to the low pressure source. A base film placed over the apertures is held to the build platform by the difference in air pressure. The movement of air from the voided internal region toward the low pressure source may be viewed as the low pressure source pulling air from the voided internal region or from a vacuum port in the build platform. As such, the low pressure source pulls air from the voided internal region.

The outer perimeter of the material substrate or base film can be sealed and secured to the build platform using adhesive tape, an O-ring, or a mechanically articulated perimeter frame. The base film is forced down onto the build platform by a difference in air pressure between the voided internal region and the outside of the build platform. The voided internal region can be held at a low pressure by the vacuum pulling assembly (i.e., vacuum vs. atmospheric). Low pressure is a relative term that herein means lower than the air pressure outside of the build platform. The air pressure outside the build platform is often the atmospheric air pressure.

The 3D printer can have an extruder that melts a parent material (e.g., the printer filament), such as PVDF, and deposits the melted parent material directly to a compatible base film. A compatible base film is a base film formed from a material that the parent material bonds to. For example, the extruder can deposit melted PVDF from a melted PVDF printer filament onto a PVDF base film, thereby bonding the parent material to the base film. The bond may be fully penetrated or may be partial. Since the base film is drawn down to the build platform surface continuously during production (e.g., printing of an additively manufactured object), warpage associated with many different types of parent materials can be minimized, and materials that do not normally adhere well to the build platform can be easily printed. The base film material can be removed and reused in some cases, or can be treated as waste in other cases. The base film may also be integrated into the additively manufactured object.

The base film material can be individually sized and textured to facilitate gas conductance. For example, patterns of grooves in the base film may provide channels for air to flow from under the base film and into the voided internal region. Individual film sheets can also have perimeter adhesives to facilitate gas seal for effective vacuum. The perimeter adhesives can seal the outside edge of the base film to the top plate of the build platform. The base film may be dispensed by rolls or folded stacks, utilizing cogged sprockets, tensioners, rollers, and indexing holes to advance new base film material across the build platform as desired. Automatic slitters can also be provided.

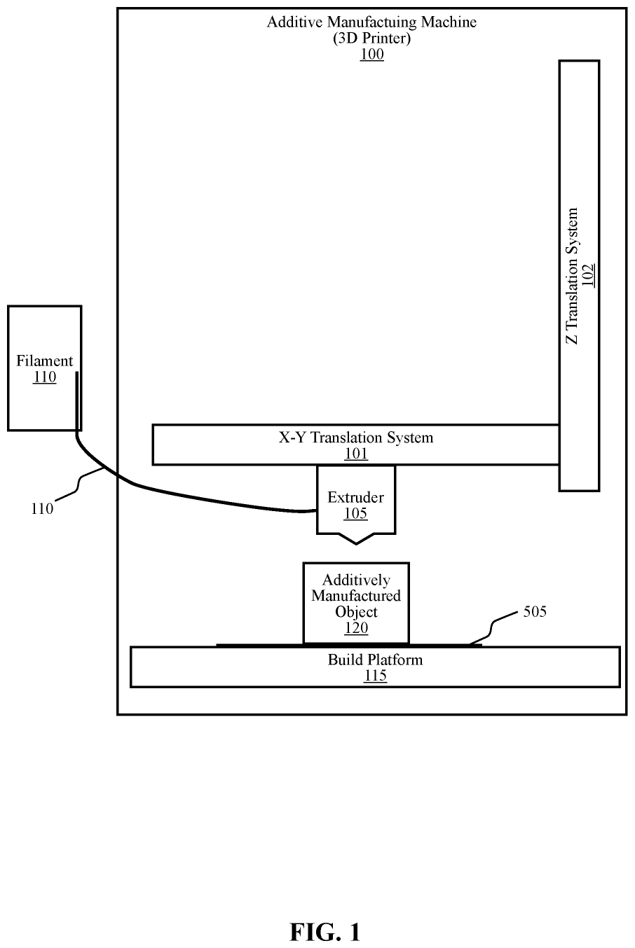

FIG. 1 is a high-level conceptual diagram illustrating an additive manufacturing machine 100 (e.g., a 3D printer) that uses a difference in air pressure to hold a base film 505 to a build platform 115 according to some aspects. In general, the 3D printer 100 can use an extruder 105 to melt filament 110. The extruder may be moved by a translation system that includes an x-y translation system 101 and a z axis translation system 102. In other systems, the build platform is moved and the extruder is stationary. In yet other systems, the build platform and the extruder are both moved. As such, the filament 110 can be deposited in specific locations on a build platform 115 and an additively manufactured object 120. The additively manufactured object 120 can then be built layer by layer, until complete. As noted, certain materials are very difficult to print because they do not adhere well to the build platform 115. One example of such a material is PVDF but other materials can be used for printing other objects.

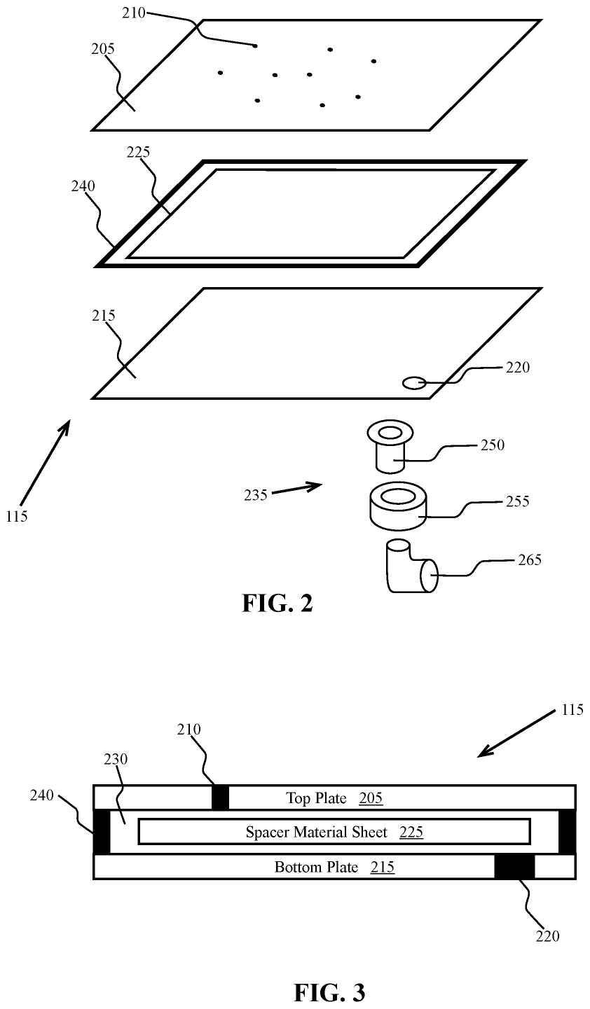

FIG. 2 is a diagram illustrating components of a build platform 115 according to some aspects. The build platform 115 can include a top plate 205 that has one or more apertures 210, as well as a bottom plate 215 with a vacuum port 220. The vacuum port 220 can comprise a hole, aperture, or other such opening in the bottom plate 215.

The top plate 205 and the bottom plate 215 can sandwich a spacer material sheet 225, that may prevent debris from clogging the build platform 200. Furthermore, the spacer material sheet 225 can prevent the top plate 205 and the bottom plate 215 from being pulled together by the difference in air pressure. The spacer material sheet 225 may facilitate thermal conductance and air flow. The spacer material sheet 225 may comprise various materials. The spacer material sheet 225 can be selected to have a smaller dimension than the associated top plate 205 and bottom plate 215 so that the spacer material sheet can be sealed between the top plate 205 and bottom plate 215. The size of the spacer material sheet 225 can be selected to be sufficiently sized to extend to all the apertures 210 in the top plate 205. The top plate 205 can be sealed to the bottom plate 215 with a sealing ring 240. As such, a voided internal region 230 can be formed between the top plate 205 and the bottom plate 215 because the sealing ring seals the voided internal region.

A vacuum pulling assembly 235 can be connected to the vacuum port 220 with a vacuum port seal 250, magnet 255 and tube fitting 265. The bottom plate 215 may be magnetic such that a magnetic force attracts the magnet 255 to the bottom plate 215. One end of a vacuum hose may be connected to the vacuum pulling assembly 235 by the tube fitting. The other end of the vacuum hose may be connected to a vacuum pump. The magnetic force thereby holds the vacuum hose to the vacuum port 220. Once a vacuum pump is connected to the vacuum hose, it can be used to draw a vacuum through the apertures 210 formed on the top plate 205 of the build platform 200.

FIG. 3 is a diagram illustrating a cut view of a build platform 115 according to some aspects. A spacer material sheet 225 is in the voided internal region between the top plate 205 and the bottom plate 215. A sealing ring 240 prevents air from flowing into or out of the outside edge of the build plate. Apertures 210 pass through the top plate 205. A vacuum port passes through the bottom plate. Other implementations may position the vacuum port at other locations such as in the top plate 205 or even at a gap in the sealing ring 240.

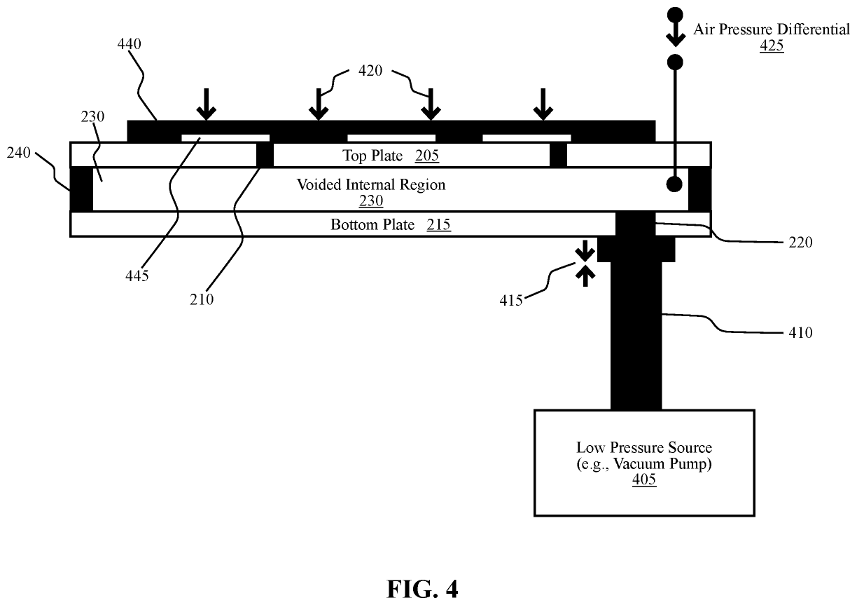

FIG. 4 is a diagram illustrating a build platform 115 attached to a low pressure source 405 according to some aspects. The base film is textured and is thereby a textured base film 440 that has a bottom texture 445 that facilitates gas conductance into at least one aperture 210 of the build platform 115. The voided internal region 230 between the top plate 205 and the bottom plate 215 is illustrated without the spacer material sheet. A magnetic force 415 is shown holding a vacuum hose 410 to the vacuum port 220. The vacuum hose is also attached to a low pressure source 405 (e.g., a vacuum pump). The low pressure source 405 draws a vacuum in the voided internal region 230, thereby creating a difference in air pressure 425 between the voided internal region and the outside of the build platform. The difference in air pressure 425 produces a force 420 that forces the base film onto the top plate 205 of the build platform 115.

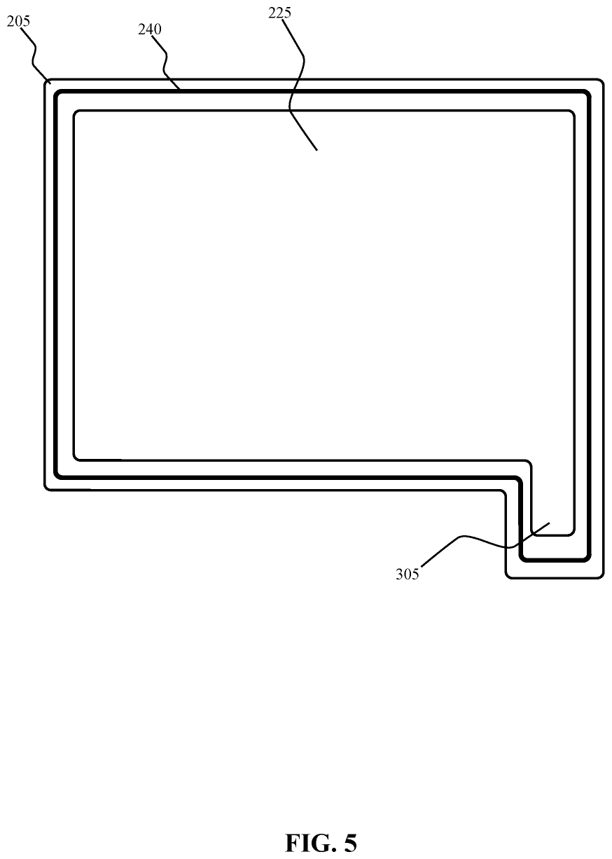

FIG. 5 is a diagram illustrating a spacer material sheet 225 and a sealing ring 240 on a top plate 205 according to some aspects. The top plate 205 can comprise a sheet of metal configured to engage with an additive manufacturing device. The top plate 205 can be configured with a top plate vacuum tab 305 at the edge of one of the sides of the top plate 205. The shape of the top plate 205 can generally be selected to be a shape that is operable with a given additive manufacturing device. The example illustrated in FIG. 5 is a square, but other shapes are possible. The one or more apertures 210 in the top plate 205 are below the spacer material sheet. A single aperture 210 may be in the center of the top plate 205. Multiple apertures may be in the top plate 205 in an aperture pattern designed to optimize the vacuum seal created between the top plate and the overlying base film. For example, the aperture pattern can include multiple holes at the corners of the plate. The apertures may have covers such that certain apertures for drawing vacuum can be selected according to the desired application.

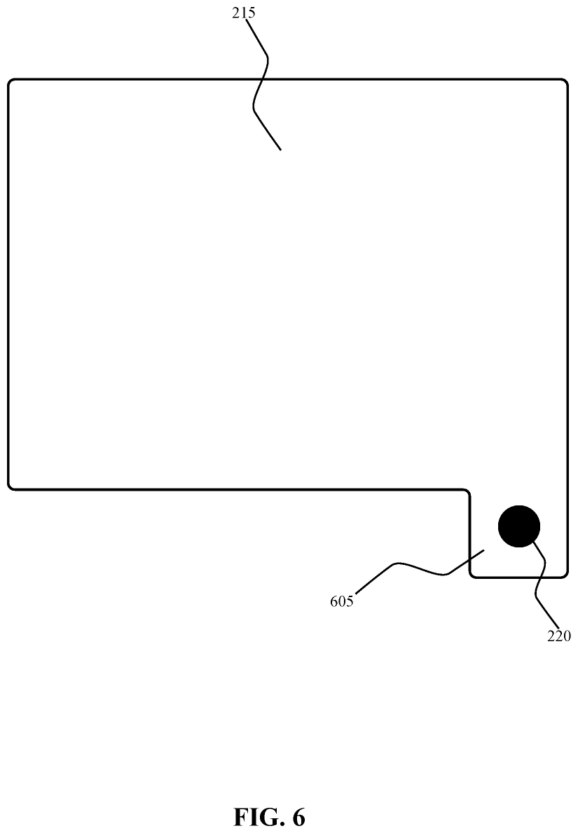

FIG. 6 is a diagram illustrating a bottom plate 215 stacked on the spacer material sheet, the sealing ring, and the top plate of FIG. 5 according to some aspects. The bottom plate 215 can comprise a metal plate or other such material. The bottom plate 215 is generally configured to match the shape of the top plate 205. The bottom plate 215 can include a bottom plate vacuum tab 605 with a general profile matching that of the top plate vacuum tab 305 on the top plate 205. The bottom plate vacuum tab 605 on the bottom plate 215 can include a vacuum port 220. The vacuum port 220 can generally comprise an orifice in the bottom plate 215 which can be fluidically connected with a low pressure source 405. The bottom plate 215 and/or the bottom plate vacuum tab 605 may be configured to be magnetic such that the vacuum pulling assembly 235 can be fitted over the vacuum port 220 as illustrated in FIG. 4 and a magnetic force holds the vacuum pulling assembly 235 to the vacuum port.

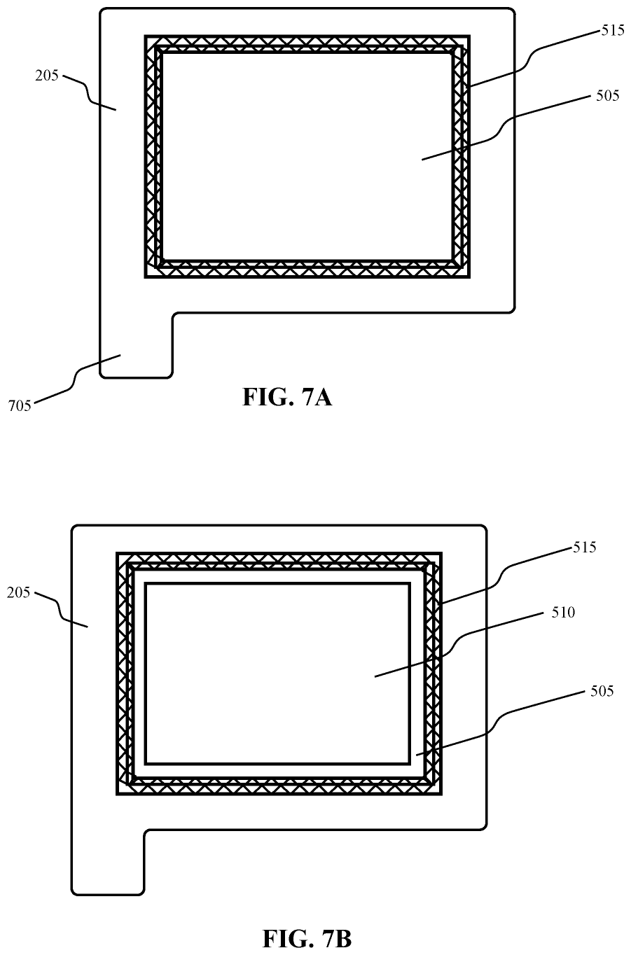

FIG. 7A is a diagram illustrating an exterior edge of the base film 505 sealed to the top plate 205 according to some aspects. The base film 505 is bound in place on the top plate 205. It should be noted that a mesh 510 may be placed on top of the top plate 205 but under the base film 505. The mesh is not shown in FIG. 7A. FIG. 7B is a diagram illustrating a mesh under the base film of FIG. 7A according to some aspects. The mesh 510 can facilitate thermal conductance and air flow into the apertures. The base film 505 can be sealed along its outer perimeter with a binder 515. The binder 515 may be tape. The base film 505 is selected to be compatible with the filament material being used for the build. In particular, the base film 505 can be selected for adhesive compatibility with the filament material, so that, as the first layer of filament material is deposited on the base film 505, the filament material adheres in place and serves as a viable foundation for the remainder of the build. The filament material and film material may be the same material. The build plate 115 has a vacuum tab 705 that includes the top plate vacuum tab 305 and the bottom plate vacuum tab 605.

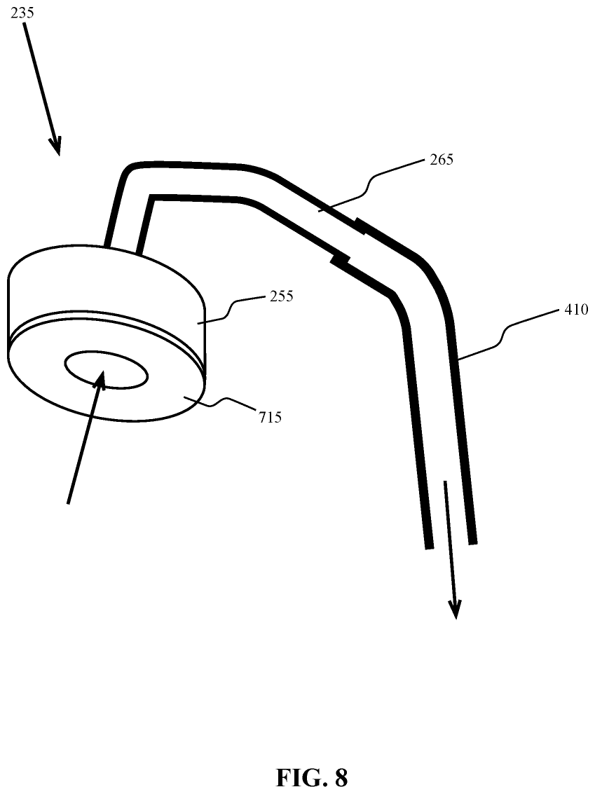

FIG. 8 is a high-level conceptual diagram illustrating a vacuum pulling assembly 235 that includes a magnet 255 that is positioned to use a magnetic force 415 to hold a vacuum hose 410 to the vacuum port 220 of a build platform 115 according to some aspects. FIG. 2 illustrates an exploded view of the vacuum pulling assembly 235 configured to engage the vacuum port 220. The vacuum pulling assembly 235 can include a vacuum port seal 250, a magnet 255 and a tube fitting 265. The magnet 255 can be the housing of vacuum pulling assembly 235. Implementations that do not use a magnetic connector may have a metallic, ceramic, or plastic housing, in which case the air pressure differential may hold the vacuum pulling assembly 235 in position on the vacuum port 220. The outer surface of the housing 255 can include a sealing layer 715 that creates an airtight seal between the vacuum pulling assembly 235 and the vacuum tab 705.

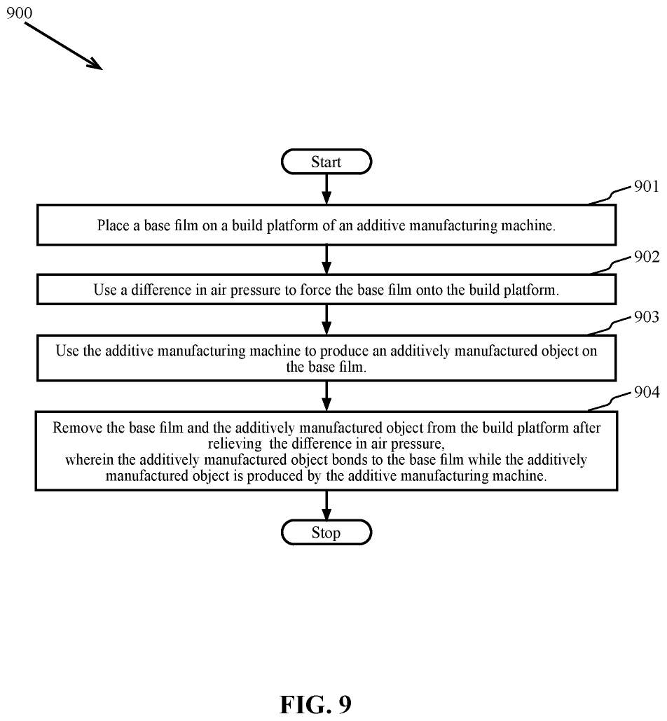

FIG. 9 is a high-level flow diagram illustrating a method for using a difference in air pressure to hold a base film to a build platform during the manufacture of an additively manufactured object 900 according to some aspects. After the start, at block 901 a base film can be placed on a build platform of an additive manufacturing machine. At block 902, a difference in air pressure can be used to force the base film onto the build platform. At block 903, the additive manufacturing machine can be used to produce an additively manufactured object on the base film. At block 904, the base film and the additively manufactured object can be removed from the build platform after relieving the difference in air pressure, wherein the additively manufactured object bonds to the base film while the additively manufactured object is produced by the additive manufacturing machine. Relieving the difference in air pressure means reducing the difference in air pressure such that the additively printed object and/or base film is released from or is easily freed from the build platform (e.g., requiring less than 10 lb. of force). The difference in air pressure can be relieved by turning off or disconnecting the low pressure source. In addition, a relief valve may be placed in line (e.g., in the vacuum hose) or in the build platform such that opening the valve allows air into the voided internal region to thereby relieve the difference in air pressure. Controlling the difference in air pressure allows for selectively attaching the base film to the build platform.

Based on the foregoing, it can be appreciated that a number of embodiments, preferred and alternative, are disclosed herein. It will be appreciated that variations of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A system comprising:
a build platform for an additive manufacturing machine; and
at least one aperture in the build platform that is positioned to use a difference in air pressure to force a base film onto the build platform,
wherein the build platform is configured for the additive manufacturing machine to produce an additively manufactured object on the base film, and
wherein the additively manufactured object bonds to the base film.

2. The system of claim 1, further including:
the additive manufacturing machine; and
a low pressure source that pulls air from a vacuum port of the build platform to thereby create the difference in the air pressure.

3. The system of claim 1, further including:
a top plate;
a bottom plate;
a vacuum port configured for pulling air from a voided internal region between the top plate and the bottom plate;
a spacer material sheet in the voided internal region; and
a sealing ring between the top plate and the bottom plate that seals the voided internal region,
wherein the at least one aperture passes through the top plate to the voided internal region,
wherein the top plate, the bottom plate, the vacuum port, the spacer material sheet, and the sealing ring are components of the build platform, and
wherein pulling the air from the vacuum port creates the difference in the air pressure that forces the base film onto the build platform.

4. The system of claim 1, wherein the additively manufactured object is a polyvinylidene fluoride (PVDF) object.

5. The system of claim 1, wherein the base film is a polyvinylidene fluoride (PVDF) base film.

6. The system of claim 1, wherein the additively manufactured object includes polyvinylidene fluoride (PVDF), and the PVDF bonds to the base film.

7. The system of claim 1 wherein:
the build platform includes a vacuum pulling assembly that includes a vacuum tab and a vacuum port on the vacuum tab; and
pulling air from the vacuum port creates the difference in the air pressure that forces the base film onto the build platform.

8. The system of claim 7 wherein:
the vacuum pulling assembly includes a magnet;
wherein the magnet is positioned to use a magnetic force to hold a vacuum hose to the vacuum port.

9. The system of claim 1 wherein:
a magnetic force holds a vacuum hose to a vacuum port of the build platform; and
pulling air from the vacuum hose creates the difference in the air pressure that forces the base film onto the build platform.

10. The system of claim 1 wherein an exterior edge of the base film is sealed to a top plate of the build platform.

11. The system of claim 1 wherein the base film is textured to facilitate gas conductance into the at least one aperture of the build platform.

12. The system of claim 1 wherein a mesh between the base film and the build platform facilitates gas conductance into the at least one aperture of the build platform.

13. The system of claim 1 wherein the difference in the air pressure forces the base film onto the build platform continuously during production of the additively manufactured object.

14. A method comprising:
placing a base film on a build platform of an additive manufacturing machine;
using a difference in air pressure to force the base film onto the build platform;
using the additive manufacturing machine to produce an additively manufactured object on the base film; and
removing the base film and the additively manufactured object from the build platform after relieving the difference in the air pressure,
wherein the additively manufactured object bonds to the base film while the additively manufactured object is produced by the additive manufacturing machine.

15. The method of claim 14, wherein the additively manufactured object is a polyvinylidene fluoride (PVDF) object.

16. The method of claim 14, wherein the base film is a polyvinylidene fluoride (PVDF) base film.

17. The method of claim 14, wherein the additively manufactured object includes polyvinylidene fluoride (PVDF), and the PVDF bonds to the base film.

18. The method of claim 14, wherein the build platform includes:
a top plate;
a bottom plate;
a vacuum port configured for pulling air from a voided internal region between the top plate and the bottom plate;
at least one aperture passing through the top plate to the voided internal region;
a spacer material sheet in the voided internal region; and
a sealing ring between the top plate and the bottom plate that seals the voided internal region,
wherein pulling the air from the vacuum port creates the difference in the air pressure that forces the base film onto the build platform.

19. A system comprising:
a means for producing an additively manufactured object; and
a means for using a difference in air pressure to selectively attach a base film to the means for producing the additively manufactured object;
wherein the additively manufactured object bonds to the base film while the additively manufactured object is produced by the means for producing the additively manufactured object.

20. The system of claim 19, wherein the additively manufactured object is a polyvinylidene fluoride (PVDF) object.
